(19) United States
(12) Patent Application Publication
(10) Pub. No.: US 2013/0245998 A1
(43) Pub. Date: Sep. 19, 2013

(54) SELECTING ENTITIES IN A SAMPLING PROCESS

(71) Applicants: Filippo Balestrieri, Mountain View, CA (US); Julie Ward Drew, Redwood City, CA (US)

(72) Inventors: Filippo Balestrieri, Mountain View, CA (US); Julie Ward Drew, Redwood City, CA (US)

(21) Appl. No.: 13/418,576

(22) Filed: Mar. 13, 2012

(51) Int. Cl. G06F 19/00

(52) U.S. Cl. 702/179

(57) ABSTRACT

As part of a sampling process, entities of a population are selected, where the population includes plural types of entities. Selecting the entities includes iteratively indicating in each of successive steps of the sampling process a corresponding type of the plural types of entities to select.

### BACKGROUND

An enterprise may desire to perform a survey of individuals to collect information about such individuals. The administration of an individual survey may be relatively costly. A survey may target a particular subset of a population of individuals. However, if insufficient information is known beforehand about the population, then the enterprise may not be able to efficiently target the particular subset in the survey.

### BRIEF DESCRIPTION OF THE DRAWINGS

Some embodiments are described with respect to the following figures:

FIG. 1 is a block diagram of an example arrangement that includes a system including a sampling module according to some implementations; and

FIGS. 2 and 3 are flow diagrams of sampling processes according to various implementations.

### DETAILED DESCRIPTION

An enterprise (e.g. a business concern, government agency, educational organization, individual, etc.) may perform a survey or other inquiry to collect information regarding a target subset of a population of entities (e.g. human individuals, computing entities, biological entities, etc.). For example, in the context of a survey of a population of human individuals, an enterprise may desire to obtain information (e.g. age, geographic location, income, interests, preferences over a specific set of products, and so forth.) regarding the majority gender group in the population, where the majority gender group can be a majority male group (males make up a majority of the population) or a majority female group (females make up a majority of the population). In the foregoing example, the target subset of individuals is the majority gender group.

However, the enterprise may not have a priori information regarding the individuals in the population; as a result, the enterprise does not know ahead of time whether the population includes a majority of males or a majority of females. If it is known beforehand that a population has a majority of males, then the enterprise would direct its survey at the male individuals in the population (and not direct any survey questions at female individuals in the population); similarly, if it is known beforehand that the population has a majority of females, then the enterprise would direct its survey at the female individuals in the population. However, if the enterprise does not know beforehand whether females or males make up the majority of the population, then the enterprise would not know which individuals to target in the survey.

In other examples, the enterprise may wish to obtain information about a subset of individuals having certain demographic characteristics (certain age, certain income level, years of schooling, and so forth) defined relative to the characteristics of the overall population (e.g. people in the most numerous age group, people with income below the 20^{th} percentile, people with a number of years of schooling below the median.) Again, if sufficient a priori information does not exist about the demographic characteristics of the population, then the enterprise would not know which individuals to target in a survey.

In many surveys, there is a constraint on the size of a sample of individuals that can be surveyed. Given such size constraint of the sample, any surveys directed at individuals in the minority group (outside the target subset of the population) means that less information can be obtained from individuals in the target subset. There is also a cost (e.g. monetary cost or time-related cost) associated with sampling. The cost may depend on how targeted the sample is. For example, it may be cheaper to take a randomly selected sample than to target a specific subset of the population. The enterprise may be concerned with managing the overall cost of sampling.

In accordance with some implementations, a sampling process provides a technique for dynamically guiding the sampling of entities in a population for enhancing the utility of information obtained from entities that are in a target subset of a population. A “target subset” of a population is the subset (less than all) of the population that has a predefined characteristic (or characteristics), such as majority gender group, and so forth. Generally, the sampling process is able to perform the following: 1) identify correctly the target subset of interest; 2) collect the additional information the enterprise is interested in obtaining

During a sampling process, entities are sampled (by submitting inquiries to the sampled entities and obtaining information from the entities in response to the inquiries). For example, if the sampling process is part of a survey process, human individuals are sampled (by submitting survey questions to the sampled individuals and obtaining survey responses to such survey questions), which allows characteristics of the sampled individuals to be discovered by the survey process. Concurrently with the ability to learn characteristics of the sampled entities, the sampling process is also able to dynamically guide the selection of entities to sample, to enhance (or maximize) the amount of useful information that can be obtained from the entities in the target subset. By being able to concurrently profile the sampled entities (learn characteristics of the entities) of a population during the sampling process and obtain information from the target subset of the population, a relatively efficient and effective sampling process is provided to enhance the amount of information that can be obtained from the target subset of the population.

For example, if the target subset of a survey process is the majority gender group of a population, then the survey process allows for concurrent identification of the majority gender group and enhancement (or maximization) of the acquisition of useful additional information from individuals in the majority gender group, which reduces the amount of information that is obtained from the minority gender group.

The sampling process according to some embodiments can be performed in the context where there is a sample size constraint that specifies a maximum number of individuals that can be selected in a sample. The sampling process according to some implementations can balance the expected value of information obtained from sampled entities with the cost of obtaining the information. Generally, the sampling process can be applied to any study in which the analysis is to be focused on a segment of the overall population that is not known a priori. This segment of the overall population that is the focus of the study is dynamically learned during the sampling process itself.

Alternatively, the sampling process can be focused on multiple segments of the overall population. The sampling process may target each of several demographic groups in a population (such as according to some demographic dimensions including age, gender, education level, etc.). As another example, the target subsets may include individuals in the top and bottom 10% of income distribution. In further examples, the sampling process may target a number of individuals in each segment in proportion to their frequency in the overall population.

A target segment may be defined in terms of multiple dimensions (e.g. majority gender and top 10% income).

In the ensuing discussion, reference is made to a “survey process,” where a “survey process” refers to a process for submitting survey questions to human individuals in a population and obtaining responses to such survey questions. However, techniques or mechanisms according to some implementations can also be employed in other types of sampling processes, in which entities of a population are selected to which inquiries are sent. An “inquiry” can refer to any of the following: survey question, test, or any other request for information. For example, in alternative examples, the sampling process can involve testing of entities, such as biological entities (e.g. bacteria, animals, etc.) or computing entities (e.g. computers, storage devices, communications devices, etc.).

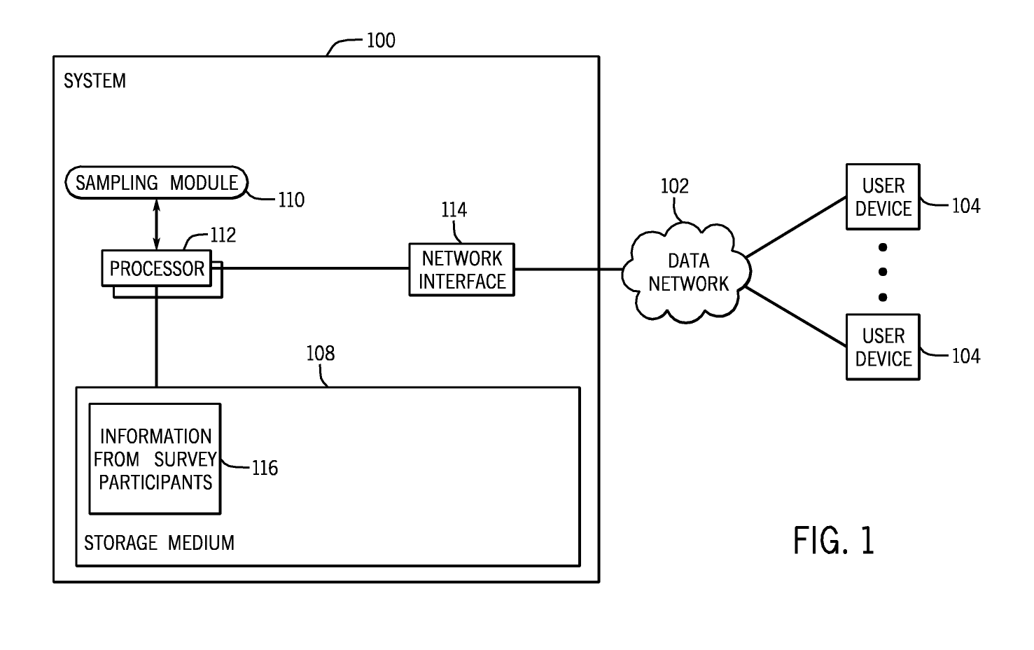

FIG. 1 illustrates a system 100 that has a sampling module 110 according to some implementations. The sampling module 110 is able to concurrently profile entities in a population to learn a target subset of the population, and obtain information from such target subset of the population (as discussed above). The sampling module 110 can be implemented as machine-readable instructions executable on a processor (or multiple processors) 112. The processor(s) 112 can be connected to a network interface 114 and to a storage medium (or storage media) 108.

The network interface 114 allows the system 100 to communicate over a data network 102 with user devices 104. Survey participants can be located at the user devices 104, where the survey participants can include the individuals that are asked survey questions by the survey sampling module 110. Survey responses to the survey questions are entered into the user devices 104 and communicated from the user devices 104 to the system 100.

In other examples, survey questions can be posed to survey participants manually, with the survey responses recorded manually and later provided to the system 100.

Information collected from the survey participants is stored in the storage medium (or media) 108 as information 116. The sampling module 110 can apply processing according to some implementations on the information 116.

More generally, the sampling module 110 is able to submit inquiries to entities of a population to obtain information from the entities in response to inquiries. As noted above, such inquiries can be survey questions submitted to survey participants. In other examples, such inquiries can be tests of other types of entities, such as computing entities or biological entities.

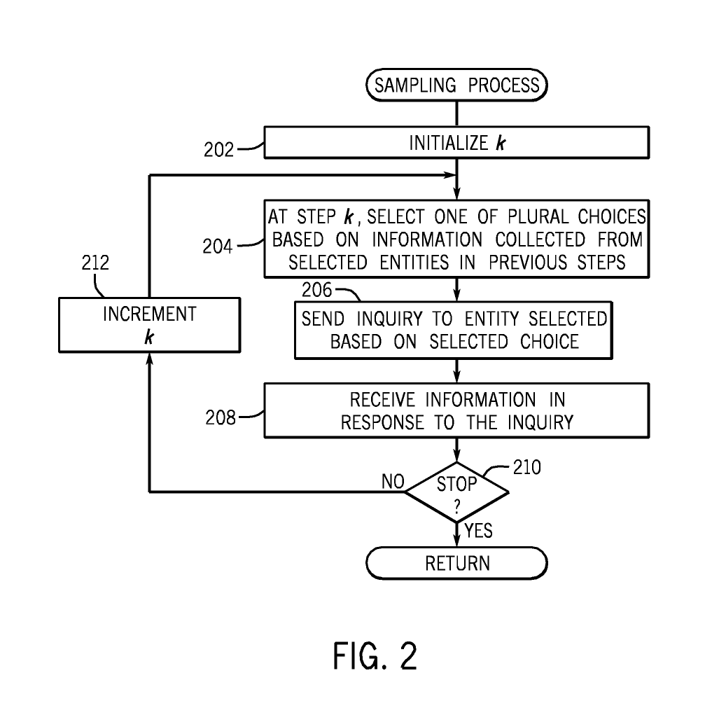

FIG. 2 is a flow diagram of a sampling process according to some implementations. In some examples, the sampling process can be performed by the sampling module 110 of FIG. 1. The sampling process is a multi-step process (having multiple steps that are iteratively performed). Entities from a population are selected at corresponding ones of the multiple steps, and inquiries are sent to the selected entities are sent to the selected entities to collect information from the selected entities. At each step of the multi-step process, information acquired from inquired entities so far is used in the selection of the next entity for the next step of the sampling process. Note that there are multiple types of entities in the population (e.g. female individuals, male individuals). Note that in the sampling process according to some implementations, information acquired at each step about one type of entity (e.g. male individual) provides information about the population distribution over all possible types (e.g. male and female individuals).

As depicted in FIG. 2, the sampling process begins by initializing (at 202) a variable k (e.g. by setting the variable k to an initial value such as 0 or other low value). The variable k can represent the number of individuals sampled so far in the sampling process. Iterating through multiple k values allows for performing multiple steps in the multi-step sampling process according to some implementations. At step k, the sampling process selects (at 204) one of plural choices, where each of the choices specifies a different manner of selecting the next individual to sample. For example, a first choice can specify that the next individual to be sampled is to be randomly selected from a population. A second choice can specify that the next individual to be selected is of a first type (e.g. a male individual), and a third choice can specify that the next individual to be selected is of a second type (e.g. a female individual). The selection of one of the plural choices can be based on information collected from selected entities in previous steps (before present step k) of the multi-step sampling process. The selected entity in step k is one of the multiple types of entities in the population (e.g. the selected entity is a female individual or a male individual).

An inquiry (e.g. one or multiple survey questions, test, or any other request for information) is then sent (at 206) to the entity k selected based on the choice selected (at 204). The sampling process then receives (at 208) information in response to the inquiry provided at 206.

Next, the sampling process determines (at 210) whether a stopping criterion has been satisfied. If so, the sampling process has concluded. On the other hand, if the stopping criterion has not been satisfied, then the variable k is incremented (at 212), and the sampling process then proceeds to the next step of the multi-step sampling process by iterating through tasks 204, 206, 208, and 210.

The sampling process continues until the stopping criterion is satisfied, as determined at 210.

In some implementations, at each step k of the multi-step sampling process, selection of the next entity (entity k at task 204 in FIG. 2) can be a selection from according to the following choices:

(1) randomly select the next entity from the population that is to be included in a sample to which an inquiry is sent;

(2) select a first type of entity;

(3) select a second type of entity; and

(4) stop the sampling process.

In the foregoing example, it is assumed that there are two types of entities (e.g. where the first type of entity can be a male individual and the second type of entity can be a female individual).

If choice (1) is made, then the sampling process selects the next entity randomly from the population. It is assumed that choice (1) entails a random selection of entities, which implies that there is no concern relating to selection bias. If choice (2) is made, then the sampling process selects the first type of entity. If choice (3) is made, then the sampling process selects the second type of entity. If choice (4) is made, then the sampling process stops.

The determination of which of the choices to make is based on information collected so far (up to the current step k), as discussed further below.

In the ensuing discussion, it is assumed that the entities of a population include male individuals (men) and female individuals (women), and the sampling process is a survey process that is to target the majority gender group.

The process involves inquiries aimed to elicit two types of information: information regarding the characteristic with respect to which the target subset is defined (e.g. gender); and any additional information (the information that is to be acquired by the survey or other inquiry) the enterprise may wish to obtain (e.g. age, income). There are two possible cases:
Case 1: the first case assumes that both types of information are elicited simultaneously (e.g. by using a printed questionnaire with all questions for distribution to survey participants); and
Case 2: the second case assumes that the two types of information can be retrieved sequentially (e.g. an electronic questionnaire is distributed where the respondent moves to the next question only if his answer to the previous question qualifies the respondent).

The two cases differ in terms of the way in which an analyst has access to the two types of information. In the first case, the analyst learns both types of information simultaneously. The analyst cannot elicit separately the two types of information. In the second case, the analyst can learn information regarding the characteristic with respect to which the target subset is defined separately and independently from any additional information.

The following describes Case 1 discussed above. In this case, it is assumed that both choice (2) and choice (3) can be implemented without affecting the analyst's information regarding the distribution of types in the population. A suitable implementation according to an example involves soliciting the entities to self-reveal themselves (e.g. inviting just males to take the questionnaire in front of a trustworthy examiner). Such an implementation can be used when type is verifiable.

In some examples, the optimal choice of an individual at any given step of a survey process depends on the maximum remaining number of individuals that are to be sampled and the outcome of the sampling so far (e.g. number of men versus number of women sampled). Such a choice is determined as a solution to the following dynamic programming problem:

$${V}_{k} ( m , n ) = max \{ - {c}_{r} + P ( observe a man \text{\textbar} m , n ) [ X \cdot P ( Men are majority \text{\textbar} m , n ) + {V}_{k + 1} ( m + 1 , n + 1 ) ] ++ P ( observe a woman \text{\textbar} m , n ) [ X \cdot P ( Women are majority \text{\textbar} m , n ) + {V}_{k + 1} ( m , n + 1 ) ] , - {c}_{m} + X \cdot P ( Men are majority \text{\textbar} m , n ) + {V}_{k + 1} ( m , n ) , - {c}_{f} + X \cdot P ( Women are majority \text{\textbar} m , n ) + {V}_{k + 1} ( m , n ) , 0 \} , \qquad ( Eq . 1 )$$

with boundary condition V_{N}(m,n)=0.

The various items in Eq. 1 are explained further below.

More generally, Eq. 1 is expressed a Vₖ(m,n)=max{v1, v2, v3, 0},
v1=−cᵣ+P(observe a man|m,n)[X·P(Men are majority|m,n)+Vₖ₊₁(m+1,n+1)]++P(observe a woman|m,n)[X·P(Women are majority|m,n)+Vₖ₊₁(m,n+1)], where
v2=−cₘ+X·P(Men are majority|m,n)+Vₖ₊₁(m,n), and
v3=−c_{f}+X·P(Women are majority|m,n)+Vₖ₊₁(m,n).

Eq. 1 presents four selection values {v1, v2, v3, 0} corresponding to the four choices (1)-(4) listed above. The choice that is made corresponds to the maximum selection value from among the four selection values {v1, v2, v3, 0} in Eq. 1. If v1 is the largest value, then choice (1) is made (randomly select the next entity from the population). If v2 is the largest value, then the first type of entity is selected (e.g. select male entity). If v3 is the largest value, then choice (3) is made (e.g. select female individual).

In alternative implementations, the technique can be generalized to comparisons in which the choice made is based on comparing values v1, v2, and v3 to predefined thresholds or other conditions. For example, choice (2) is selected in response to v2 being greater than v3 and greater than v1·b, where b is a predefined constant. In this manner, the choice that is made can be biased towards one of the choices—for example, if an analyst is risk averse, the analyst may want to use choice (2) or choice (3) only when the values of v2 and v3 are sufficiently higher than v1.

If 0 is the largest value, then the survey process is stopped (this corresponds to the stopping criterion being satisfied). In other examples, the survey process is stopped if the largest value is below some predetermined value.

The sampling size constraint is represented as N (where N is the maximum number of individuals that can be sampled). Vₖ(m,n) is the maximum expected net utility (utility minus sampling costs) from the remaining N-k individuals that can be sampled, given that the survey process has observed m men out of n randomly collected individuals in the sample, and k is the total number of individuals in the sample selected so far, both randomly sampled (n) according to choice (1) and targeted according to choice (2) or (3). Moreover, in Eq. 1, X is the per-unit utility that an analyst extracts from a relevant individual (that is part of the target subset) in the sample. In addition, cᵣ represents the cost to randomly select an individual from the population (according to choice (1)), cₘ represents the cost to select a first type individual (e.g. male individual), and c_{f} represents the cost to select a second type individual (e.g. female individual).

Eq. 1 also specifies a boundary condition V_{N}(m,n)=0. This boundary condition specifies that after N individuals have been selected for the sample, the expected net utility of selecting another individual is 0 since the maximum sample size has been reached.

In Eq. 1, P(observe a man|m, n) is the probability of observing a man in the next random selection after having observed m men out of n randomly sampled individuals. This probability can be calculated using a Bayesian approach, such as described in George Casella et al., “Statistical Inference” (2001). Similarly, P(observea woman|m,n) is the probability of observing a woman in the next random selection after having observed m men out of n randomly sampled individuals. At the first step (step 0), the probabilities P(observe a man|m,n) and P(observea woman|m,n) are considered “priors.” A “prior” is the corresponding probability of observing a man or woman in the next draw before an action is taken according to choice (1), (2), or (3). After the action is taken, then the probability becomes a posterior probability. After the first step, the “prior” probability can be referred to as an ex-ante probability.

At each step k, the prior or ex-ante probability of observing a man (or woman, P(observe a man|m, n) or P(observea woman|m,n), is updated with the sampled information (sampled at step k) according to Bayes' rule.

In Eq. 1, P(Men are majority|m,n) is the probability that the population includes a majority of men, after having observed m men out of n randomly sampled individuals; and P(Womenare majority|m,n) is the probability that the population includes a majority of women, after having observed m men out of n randomly sampled individuals.

Vₖ₊₁(m,n) is defined analogously to Vₖ(m,n). Vₖ₊₁(m,n) is the maximum expected net utility from the remaining N−(k+1) individuals that can be sampled given that the survey process has observed m men out of n randomly collected individuals in the sample, and k+1 is the total number of individuals in the sample selected so far, both randomly sampled (n) according to choice (1) and targeted according to choice (2) or (3). Similarly, Vₖ₊₁(m,n+1) and Vₖ₊₁(m+1,n) are the maximum expected net utilities from the remaining N−(k+1) individuals given that the survey process has observed m (respectively, m+1) men out of n+1 randomly collected individuals in the sample, and k+1 is the total number of individuals in the sample selected so far.

Note that the Vₖ values are computed backwards from k=N. For k=N, Vₖ for all values of m and n is known from the boundary conditions. The process can then compute Vₖ for all values of m and n for k=N−1, then for k=N−2, etc, to k=0.

Once all Vₖ values are precomputed, the techniques according to some implementations can be applied, starting with k=0.

In some examples, the values of P(Men are majority|m,n) and P(Womenare majority|m,n) can be calculated using a power function Ψ(•) of a hypothesis test with null hypothesis H₀ that men are majority. The power function Ψ(•) is the probability of rejecting the null hypothesis given the sample results and the survey performed.

Focusing on the calculation of P(Men are majority|m,n), a test (e.g. Likelihood Ratio test or a Bayesian test) can be defined, where the hypothesis (H₀) to be tested is that men are the majority in a population. Given this test, a Type I error is rejecting the hypothesis when the hypothesis H₀ is true (e.g. saying that women are the majority when the truth is that men are the majority). A Type II error is accepting the hypothesis H₀ when the hypothesis is false (e.g. saying that men are the majority when the truth is that women are the majority). The power function Ψ(•) can be defined as the probability of rejecting the hypothesis (e.g. rejecting that men are majority, ergo stating that women are majority).

If M is defined as the proportion of men in the population, then the hypothesis H₀, can be defined as follows: H₀:M>0.5.

### Then,

$${Ψ}_{M} ( m , n ) = \{ \begin{matrix}Prob of Type I Error if M > 0.5 \\ 1 - Prob of Type II Error if M \leq 0.5\end{matrix}$$

The ideal power function Ψ_{M}(m,n) is 0 if M>0.5 and 1 if M<0.5.
P(Men are majority|m,n)=1−Ψ_{M}(m,n)

The probability P(Women are majority|m,n) can be computed in similar fashion.

It is noted that a larger sample size (represented by larger values of n) would result in a more powerful (accurate) test. If the Bayesian approach is used, then a larger sample size means that more accurate updates of the ex-ante probabilities discussed above can be provided.

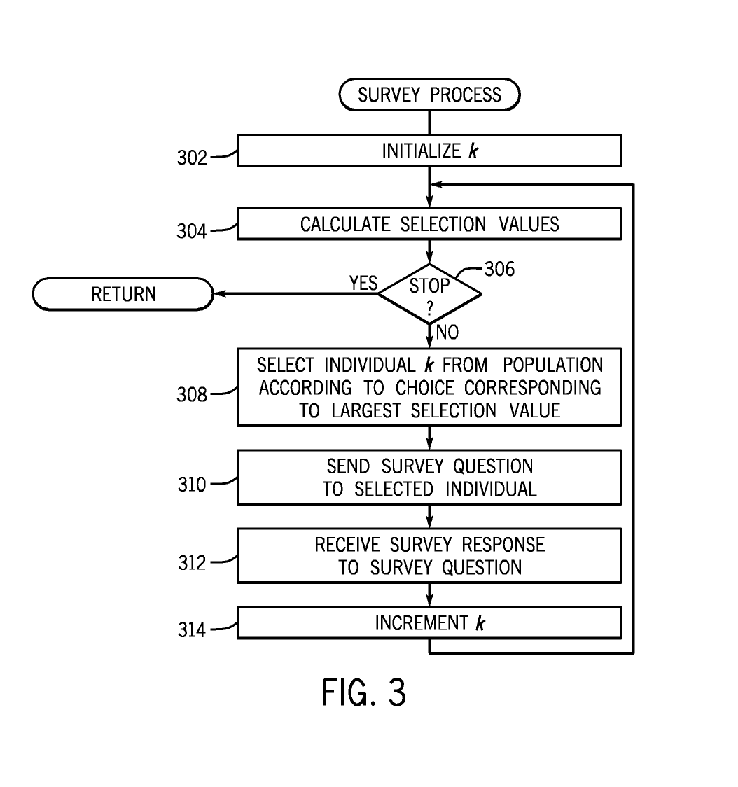

FIG. 3 is a flow diagram of a survey process according to further implementations, which can be performed by the sampling module 110 of FIG. 1, for example. The survey process of FIG. 3 is a multi-step process that has multiple steps, represented by the variable k. As with the FIG. 2 process, the variable k is initialized (at 302). The survey process then calculates (at 304) multiple selection values (e.g. v1, v2, v3 discussed above in connection with Eq. 1) corresponding to the multiple choices (e.g. choices (1)-(4) noted above) for selection of the individual k from the population. The selection values are based on information collected so far from selected individuals—the selection values guide the selection of a corresponding type of the multiple types of individuals (e.g. random selection, male individuals or female individuals) for a current step of the multi-step survey process.

The survey process then determines (at 306) whether a stopping criterion has been satisfied. As discussed above, the stopping criterion is satisfied if 0 is the largest value from among the selection values {v1, v2, v3, 0} (according to Eq. 1 above). If the stopping criterion is satisfied, then the survey process stops.

However, if the stopping criterion is not satisfied, then the survey process selects (at 308) individual k from the population according to the choice corresponding to the largest selection value (e.g. the individual k is randomly selected from the population, a first type individual is selected, and a second type individual is selected). The survey process sends (at 310) a survey question (or survey questions) to the selected individual. The survey process then receives (at 312) a survey response to the survey question. The variable k is incremented (at 314), and the tasks 304-314 are iterated.

The following describes Case 2 noted above. In this case, it is assumed that two separate inquiries can be addressed to the entities in the population in order to retrieve information regarding the characteristic (e.g. gender) that determines their qualification to the target subset and the additional information (e.g. income, age) the enterprise may wish to collect as part of the survey or other inquiry.

Although the two-inquiry process in Case 2 may be administered in a sequential manner (e.g. first identify the majority gender, then submit the samples only to entities of that gender), budget constraints may specify that implementing the two-inquiry process in a fully sequential manner may not be feasible. For example, the time or cost involved in first identifying the majority gender in a population, followed by submitting inquiries to just individuals of the majority gender, may not be feasible given the budget constraints.

In some implementations, a sampling process for Case 2 can also involve selections from among the four choices, choices (1)-(4) discussed above. However, for Case 2, choice (2) and choice (3) are implemented differently than for Case 1 above. Choices (2) and (3) are implemented in a way that affects the analyst's information regarding the distribution of types in the population. In some examples, the analyst can randomly draw entities from the population and retrieve information about their type through an inquiry. After each draw, the analyst updates the analyst's information regarding the distribution of types in the population.

When the recommended action is choice (2), the analyst can keep drawing entities from the population until the analyst encounters an entity of the first type (the “qualified entity” according to choice (2)). Once that happens, the qualified entity is included in the sample and a further inquiry is administered to the qualified entity.

When the recommended action is choice (3), the analyst can keep drawing entities from the population until the analyst encounters an entity of the second type. Once that happens, the qualified entity is included in the sample and a further inquiry is administered to the qualified entity.

In some examples, the optimal choice of an individual to be included in the sample at any given step of a survey process depends on the remaining number of individuals that are to be inquired and the outcome of the inquiry so far (e.g. number of men versus number of women sampled). Such a choice is determined as a solution to the following dynamic programming problem:

Vₖ(m,n)=max{v1, v2, v3, 0}, where

$$v 1 = - {c}_{r} + P ( observe a man \text{\textbar} m , n ) [ X \cdot P ( Men are majority \text{\textbar} m , n ) + {V}_{k + 1} ( m + 1 , n + 1 ) ] ++ P ( observe a woman \text{\textbar} m , n ) [ X \cdot P ( Women are majority \text{\textbar} m , n ) + {V}_{k + 1} ( m , n + 1 ) ] , \\ v 2 = - {c}_{m} + X \cdot P ( Men are majority \text{\textbar} m , n ) ++ {\sum }_{j = 0}^{∞} P ( observe j consecutive women before observing a man \text{\textbar} m , n ) {V}_{k + 1} ( m + 1 , n + j + 1 ) , \\ and \\ v 3 = - {c}_{f} + X \cdot P ( Women are majority \text{\textbar} m , n ) ++ {\sum }_{j = 0}^{∞} P ( observe j consecutive men before observing a woman \text{\textbar} m , n ) {V}_{k + 1} ( m + j , n + j + 1 ) . \qquad ( Eq . 2 )$$

with boundary condition V_{A}, (m,n)=0.

The choice that is made corresponds to the maximum selection value from among the four selection values {v1, v2, v3, 0}. If v1 is the largest value, then choice (1) is made (randomly select the next entity from the population and include it in the sample). If v2 is the largest value, then the analyst draws entities from the population until an entity of the first type is found. In that case the entity is selected for entering (e.g. select male entity). If v3 is the largest value, then choice (3) is made (e.g. select female individual).

In alternative implementations, the technique can be generalized to comparisons in which the choice made is based on comparing values v1, v2, and v3 to predefined thresholds or other conditions.

In some examples, it is assumed that the sampling process is constrained by a maximum sample size N.

For all the expressions in Eq. 2 that also appear in Eq. 1, the definitions introduced for Eq. 1 apply.

The expression P(observej consecutive womenbeforeobservinga man|m, n)==P(observe a man|m,n)P(observe a woman|m,n)^{j} measures the probability that j consecutive females are observed followed ?by 1 male, given that you started in state (m,n).

The expression P(observej consecutive men beforeobservinga woman|m, n)==P(observe a woman|m,n)P(observe a man|m,n)^{j} measures the probability that you observe j consecutive men followed by 1 woman, given that the process started in state (m,n).

In the previous examples, the choices are defined in terms of the entities to include in the sample (e.g. random, male, or female). If the technique does not select the choice of stopping the sampling procedure, it reaches the next step only after having included a new entity in the sample. However, now, the analyst can learn information regarding the type distribution over the population through inquiries in between two iterations. The information collected may be enough to convince the analyst to change the strategy (e.g. do not include a male entity in the sample, but a female). In such examples, a technique can be provided that allows the analyst to change strategies without waiting to include a new entity in the sample information, but purely based on the information collected through the inquiries over the types.

The choices can now be:
draw an entity from the population, inquire the type, and include whatever is drawn in the sample;
draw an entity from the population, inquire the type and include the entity in the sample only if the entity is male; otherwise draw a new entity from the population;
draw an entity from the population, inquire the type and include the entity in the sample only if the entity is female; otherwise draw a new entity from the population;
draw an entity from the population, inquire the type, do not include the entity in the sample, and draw a new entity from the population;
stop

Such a choice is determined as a solution to the following dynamic programming problem: Vₖ(m,n)=max|v1, v2, v3, v4, 0), where

$$v 1 = - {c}_{i} - {c}_{r} + P ( observe a man \text{\textbar} m , n ) [ X \cdot P ( Men are majority \text{\textbar} m , n ) + {V}_{k + 1} ( m + 1 , n + 1 ) ] ++ P ( observe a woman \text{\textbar} m , n ) [ X \cdot P ( Women are majority \text{\textbar} m , n ) + {V}_{k + 1} ( m , n + 1 ) ] , \\ v 2 = - {c}_{i} + P ( observe a man \text{\textbar} m , n ) [ - {c}_{m} + X \cdot P ( Men are majority \text{\textbar} m , n ) + {V}_{k + 1} ( m + 1 , n + 1 ) ] ++ P ( observe a woman \text{\textbar} m , n ) [ {V}_{k} ( m , n + 1 ) ] , \\ and \\ v 3 = - {c}_{i} + P ( observe a woman \text{\textbar} m , n ) [ - {c}_{f} + X \cdot P ( Women are majority \vert m , n ) + {V}_{k + 1} ( m , n + 1 ) ] ++ P ( observe a man \text{\textbar} m , n ) [ {V}_{k} ( m + 1 , n + 1 ) ] , \\ v 4 = - {c}_{i} + P ( observe a man \text{\textbar} m , n ) [ {V}_{k} ( m + 1 , n + 1 ) ] + P ( observe a woman \text{\textbar} m , n ) [ {V}_{k} ( m , n + 1 ) ] .$$

with boundary condition V_{N}(m,n)=0.

Compared to the previous formulas, now the variable m defines the number of male entities observed in n random draws/inquiries. Instead, the value of k still defines the number of qualified entities that were included in the sample, where the sample has a maximum size of N. The value cᵢ represents the cost to inquire the type of a random draw from the population. Notice that in this new formulation the strategy of fully sequencing the determination of the majority gender and then target only elements of that type is part of the feasible set.

Machine-readable instructions of modules described above (including the sampling module 110 of FIG. 1) are loaded for execution on a processor(s) (such as 112 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
as part of a sampling process, selecting entities of a population to which inquiries are sent, wherein the population includes plural types of entities, and
wherein selecting the entities comprises iteratively indicating in each of successive steps of the sampling process a corresponding type of the plural types of entities to select, based on information associated with entities to which inquiries have been sent.

2. The method of claim 1, wherein the information associated with entities to which inquiries have been sent includes information regarding numbers of members of a given one of the plural types of entities that have been observed out of a number of entities selected up to a corresponding step of the sampling process.

3. The method of claim 1, wherein the information associated with entities to which inquiries have been sent includes information regarding numbers of members of a given one of the plural types of entities that have been observed out of a number of entities randomly selected up to a corresponding step of the sampling process.

4. The method of claim 1, wherein iteratively indicating in each of the successive steps of the sampling process a corresponding type of the plural types of entities to select is based on a probability of observing a specific type of the plural types of entities given that a number of entities of the specific type has been observed out of a number of entities randomly selected up to a corresponding step of the sampling process.

5. The method of claim 4, wherein the iteratively indicating is further based on a comparison of expected utilities each associated with a feasible successive step of the sampling process given that the number of the entities of the specific type has been observed out of the number of entities selected up to the corresponding step of the sampling process.

6. The method of claim 1, wherein the sampling process is a survey process, and the inquiries are survey questions.

7. The method of claim 1, wherein the sampling process is a test process, and the inquiries are tests of selected entities.

8. The method of claim 1, wherein the sampling process is to be directed at a target subset of the population, and wherein sufficient a priori information about the target subset is unavailable.

9. The method of claim 1, wherein indicating in a particular one of the successive steps of the sampling process a corresponding type of the plural types of entities to select comprises computing multiple selection values corresponding to different types of selections to be made, wherein the indicating is based on the selection values satisfying a predefined criterion.

10. An article comprising at least one machine-readable storage medium storing instructions that upon execution cause a system to:
perform a sampling process that has a plurality of steps, wherein the sampling process is to perform sampling of entities of a population having a plurality of types of entities; and
at each of the plurality of steps, indicating which of multiple choices to use for selecting a next entity of the population, wherein the choices correspond to different forms of selections of entities.

11. The article of claim 10, wherein the choices include at least two selected from among: randomly select the next entity of the population, select a first type of entity from the population, and select a second type of entity from the population.

12. The article of claim 10, wherein the instructions upon execution cause the system to further:
compute selection values corresponding to the multiple choices, wherein selection of the multiple choices is based on the selection values satisfying a predefined criterion.

13. The article of claim 12, wherein the predefined criterion specifies selection of one of the multiple choices associated with a largest one of the selection values.

14. The article of claim 13, wherein the instructions upon execution cause the system to further:
stop the sampling process if the largest selection value is below a predefined value.

15. The article of claim 10, wherein the instructions upon execution cause the system to further:
send an inquiry to the selected entity; and
receive a response to the inquiry.

16. The article of claim 15, wherein the sampling process is a survey process, and wherein the inquiry includes at least one survey question.

17. The article of claim 15, wherein the sampling process is a test process, and wherein the inquiry is a test.

18. The article of claim 10, wherein a particular one of the choices selects a particular type of entity from the population, and wherein the instructions upon execution cause the system to:
if the particular choice is indicated, send successive inquiries to entities of the population until an entity of the particular type is identified; and
send a further inquiry to the identified entity to obtain additional information in the corresponding step of the sampling process.

19. A system comprising:
at least one processor to:
as part of a sampling process, select entities of a population to which inquiries are sent, wherein the population includes plural types of entities,
wherein selecting the entities comprises iteratively indicating in each of successive steps of the sampling process a corresponding type of the plural types of entities to select, based on information associated with entities to which inquiries have been sent.

20. The system of claim 19, wherein the information associated with entities to which inquiries have been sent includes information regarding numbers of members of a given one of the plural types of entities that have been observed out of a number of entities selected up to a corresponding step of the sampling process.
